(19) United States
(12) Patent Application Publication
(10) Pub. No.: US 2011/0195835 A1
(43) Pub. Date: Aug. 11, 2011

(54) DIELECTRIC CERAMIC COMPOSITION AND ELECTRONIC DEVICE

(75) Inventors: Takashi KOJIMA, Tokyo (JP); Tomoya SHIBASAKI, Tokyo (JP)

(73) Assignee: TDK CORPORATION, TOKYO (JP)

(21) Appl. No.: 13/017,530

(22) Filed: Jan. 31, 2011

(30) Foreign Application Priority Data
Feb. 9, 2010 (JP) 2010-026906

(51) Int. Cl. C04B 35/468

(52) U.S. Cl. 501/138; 501/139; 501/137

(57) ABSTRACT

A dielectric ceramic composition comprising a main component expressed by a general formula (Ba_{1-x-y}SrₓCa_{y})ₘ(Ti_{1-z}Zr_{z})O₃, Mg oxide, oxides of at least one kind selected from Mn and Cr, rare earth oxide, an oxide including Si and a composite oxide including Ba, Sr and Zr. The general formula shows that 0.20≦x≦0.40, 0≦y≦0.20, 0≦z≦0.30, and 0.950≦m≦1.050. Within a temperature range of −25 to 105° C., a capacitance change rate on the basis of a capacitance at 25° C. is within −15 to +5% with respect to slope “a” which shows capacity temperature characteristic on the basis of the capacitance at 25° C., and the slope “a” is −5500 to −1800 ppm/° C. By the present invention, a dielectric ceramic composition which is able to set the capacitance change rate to a predetermined range with respect to absolute value of capacity temperature characteristic within a wide temperature range even when the absolute value is large can be obtained.

### BACKGROUND OF THE INVENTION

1. Field of the Invention

The present invention relates to a dielectric ceramic composition and an electronic device. For more detail, the present invention relates to a dielectric ceramic composition which is able to set a capacitance change rate to a predetermined range with respect to an absolute value of a capacity temperature characteristic within a wide temperature range even when the absolute value is large; and also the present invention relates to an electronic device having a dielectric layer composed of said dielectric ceramic composition.

2. Description of the Related Art

VR (Voltage Regulator) is a system regulating voltage of DC/DC converter, which drives CPU of a notebook computer or so. An inductor resistance (Rdc) detects an output current of VR, however, there was a problem that an error arises in the detected value since Rdc varies due to heat or so. Therefore, it is required to use properly within a wide temperature range.

In the present state, NTC thermistor is used to revise the error of the detected value.

Further, the capacitor is normally used for a circuit of VR system. It is thought that, by using the capacitor showing large absolute value of the capacity temperature characteristic, such as around −5000 ppm/° C., the error can be revised. As a result of using this method, NTC thermistor is not required, and its cost is reduced, which is an advantage.

On the other hand, there is a demand for a capacitor showing small absolute value of the capacity temperature characteristic (the capacitance change is small with respect to the temperature change), therefore, a capacitor showing large absolute value of the capacity temperature characteristic is scarcely informed. Note that the absolute value of the capacity temperature characteristic of normal capacitor is at most around −1000 ppm/° C. or 350 ppm/° C.

Japanese Utility Model Publication No. H5-61998 describes a ceramic capacitor using a ceramic as a dielectric which shows the capacity temperature characteristic of −1500 ppm/° C. to −5000 ppm/° C. and includes 20 to 95 wt % of SrTiO₃. However, the composition of the dielectric layer of the ceramic capacitor described in Japanese Utility Model Publication No. H5-61998 is partially unidentified and the other components are totally unidentified. Further, the publication does not indicate that the temperature range in which the above capacitor temperature characteristic is realized.

### BRIEF SUMMARY OF THE INVENTION

A purpose of the present invention, reflecting this situation, is to provide a dielectric ceramic composition which is able to set capacitance change rate to a predetermined range with respect to absolute value of capacity temperature characteristic within a wide temperature range even when the absolute value is large, and an electronic device having a dielectric layer composed of the dielectric ceramic composition.

As a result of keen examination in order to attain the above objects, the present inventors found that a dielectric ceramic composition having specific composition has large capacity temperature characteristic, and furthermore is able to set the change rate to a predetermined range with respect to the capacity temperature characteristic within a wide temperature range, which led to a completion of the invention.

To attain the above object, a dielectric ceramic composition of the invention includes

a main component expressed by a general formula of (Ba_{1-x-y}SrₓCa_{y})ₘ(Ti_{1-z}Zr)_{z})O₃,
a first subcomponent consisting of an oxide of Mg,
a second subcomponent consisting of an oxide of at least one kind element selected from Mn and Cr,
a third subcomponent consisting of an oxide of R, where R is at least one kind selected from Y, La Ce, Pr, Nd, Sm, Gd, Tb, Dy, Ho and Yb,
a fourth subcomponent consisting of an oxide including Si, and a sixth subcomponent consisting of a composite oxide including Ba, Sr and Zr, wherein in the general formula, “x” is 0.20≦x≦0.40, “y” is 0≦y≦0.20, “z” is 0≦z≦0.30, and “m” is 0.950≦m≦1.050,
ratios of the respective subcomponents with respect to 100 moles of said main component are
the first subcomponent: 0.5 to 5 moles (in terms of element),
the second subcomponent: 0.05 to 2 moles (in terms of element),
the third subcomponent: 1 to 8 moles (in terms of element),
the fourth subcomponent: 0.5 to 5 moles (in terms of an oxide or a composite oxide),
the sixth subcomponent: 5 to 30 moles (in terms of a composite oxide) and within a temperature range of −25 to 105° C., a capacitance change rate on the basis of a capacitance at 25° C. is within −15 to +5%, with respect to slope “a” which shows the capacity temperature characteristic on the basis of the capacitance at 25° C., and the slope “a” is −5500 to −1800 ppm/° C.

Preferably, the dielectric ceramic composition includes the main component where the “y” and “z” are 0 in the general formula.

Preferably, the dielectric ceramic composition includes a fifth subcomponent consisting of an oxide of at least one kind of element selected from the group consisting of V, Mo, W, Ta and Nb, and a ratio of the fifth subcomponent with respect to 100 moles of the main component is 0 to 0.2 moles in terms of each element.

An electronic device according to the present invention is the electronic device having a dielectric layer composed of the dielectric ceramic composition described in any one of the above. Such electronic device is not particularly limited, and is, for example, a multilayer ceramic capacitor having a capacitor element body in which dielectric layers and internal electrode layers are alternately stacked.

According to the present invention, since the dielectric ceramic composition has the above compositions, within a wide temperature range (e.g. −25 to 105° C.), the dielectric ceramic composition is able to set a capacitance change rate on the basis of a capacitance at 25° C. to the range of −15 to +5%, with respect to slope “a” which shows capacity temperature characteristic on the basis of the capacitance at 25° C. The slope “a” is in the range of −5500 to −1800 ppm/° C.

Also, particularly, by changing the content of the sixth subcomponent, the slope “a” can be easily controlled within the above range, furthermore, with respect to the slope “a”, a capacitance change rate can be easily set within the above range.

Accordingly, by using dielectric ceramic composition of the present invention as the dielectric layer of electronic device such as multilayer ceramic capacitor, it is possible to revise an error of a detected value of the output voltage of VR caused by variation of Rdc without using NTC thermistor, for instance. Further, as far as the dielectric ceramic composition determined in the present invention is used and its absolute value of the capacity temperature characteristic is required to be large, its application is not particularly limited.

Reasons for capability of obtaining these dielectric ceramic compositions can be said as following.

An absolute value of the capacity temperature characteristic of SrTiO₃ is relatively large (−3300 ppm/° C.), however, a peak of its specific permittivity is shown at a considerably low temperature when compared to an ordinal temperature range (−25° C. to 105° C.). Note that the peak is shown near Curie temperature.

Therefore, by shifting this peak toward a higher temperature, a part showing a large inclination at a higher temperature than the temperature shown by the peak will be within an ordinal temperature range. As the method for shifting the peak toward a higher temperature, it can be considered to substitute a part of SrTiO₃ to Ba. An element having a large ionic radius, such as Ba, has an effect to shift the peak toward a higher temperature.

According to the present invention, with the method described above, the peak of specific permittivity is shifted toward a higher temperature, therefore, the part showing the large inclination at the higher temperature than the temperature shown by the peak will be within an ordinal temperature range (−25° C. to 105° C.). As a result, a dielectric ceramic composition showing larger absolute value of the capacity temperature characteristic within the above temperature range can be obtained.

Further, by including the above mentioned subcomponents, a slope with a large inclination, namely, a large absolute value of the capacity temperature characteristic can be maintained and the capacitance change rate can be set in a predetermined range while attaining desirable characteristics.

### BRIEF DESCRIPTION OF THE DRAWINGS

FIG. 1 is a perspective view of a multilayer ceramic capacitor according to an embodiment of the present invention.

FIG. 2A is a graph showing a parallelogram surrounded by lines showing a capacitance change rate of −15 and +5%, respectively, with respect to a line showing a capacity temperature characteristic on the basis of capacitance at 25° C. and having a slope of −5000 ppm/° C., and also by lines showing temperatures of −25° C. and 105° C., respectively.

FIG. 2B is a graph showing a parallelogram surrounded by lines showing the capacitance change rate of −15 and +5%, respectively, with respect to a line showing the capacity temperature characteristic on the basis of capacitance at 25° C. and having a slope of −3000 ppm/° C., and also by lines showing temperatures of −25° C. and 105° C., respectively.

FIG. 3A is a graph showing capacity temperature characteristic on the basis of capacitance at 25° C. of the sample according to the present example when the content of the sixth subcomponent is set to 0 mole with respect to 100 moles of the main component.

FIG. 3B is a graph showing capacity temperature characteristic on the basis of capacitance at 25° C. of the sample according to the present example when the content of the sixth subcomponent is set to 5 moles with respect to 100 moles of the main component.

FIG. 3C is a graph showing capacity temperature characteristic on the basis of capacitance at 25° C. of the sample according to the present example when the content of the sixth subcomponent is set to 15 moles with respect to 100 moles of the main component.

FIG. 3D is a graph showing capacity temperature characteristic on the basis of capacitance at 25° C. of the sample according to the present example when the content of the sixth subcomponent to 30 moles with respect to 100 moles of the main component.

### DETAILED DESCRIPTION OF THE INVENTION

Hereinafter, the present invention will be described based on embodiments shown in drawings.

(Multilayer Ceramic Capacitor 1)

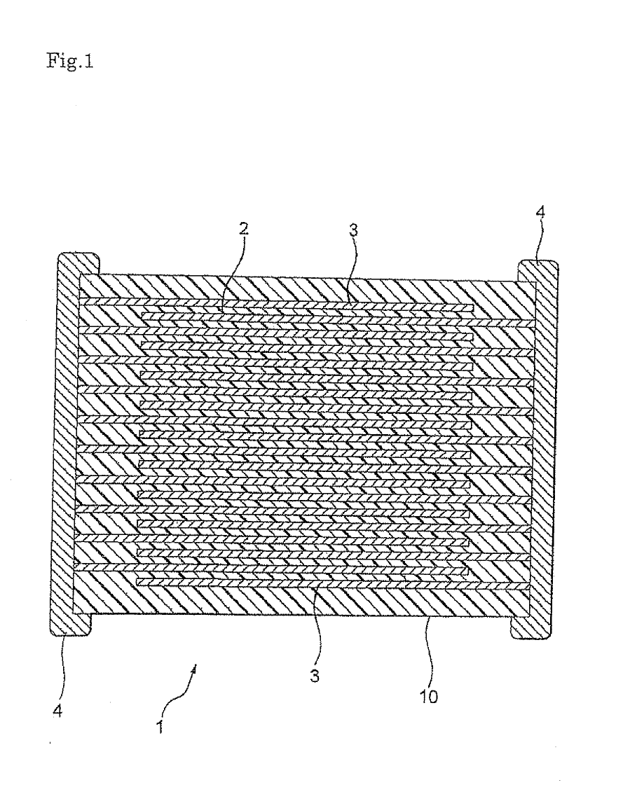

As shown in FIG. 1, a multilayer ceramic capacitor 1 according to an embodiment of the present invention has a capacitor element body 10 in which dielectric layers 2 and internal electrode layers 3 are alternately stacked. On both end portions of the capacitor element body 10, a pair of external electrode 4 is formed to be connected respectively to the internal electrode layers 3 alternately arranged inside the element body 10. The shape of the capacitor element body 10 is not particularly limited and generally rectangular parallelepiped. Further, the size of the capacitor element body 10 is not particularly limited and it may be decided appropriately in accordance with the use.

The internal electrode layers 3 are stacked, so that each of the end surfaces is alternately exposed to surfaces of the two facing end portions of the capacitor element body 10. The pair of external electrodes 4 are formed on both end portions of the capacitor element body 10 and connected to the exposed end surfaces of the alternately arranged internal electrode layers 3 so as to compose a capacitor circuit.

(Dielectric Layer 2)

The dielectric layer 2 includes a dielectric ceramic composition according to the present embodiment. The dielectric ceramic composition according to the present embodiment includes a main component expressed by a general formula (Ba_{1-x-y}SrₓCa_{y})ₘ(Ti_{1-z}Zr_{z})O₃, a first subcomponent consisting of an oxide of Mg, a second subcomponent consisting of an oxide of at least one kind of element selected from Mn and Cr, a third subcomponent consisting of an oxide of R, where R is at least one kind selected from Y, La Ce, Pr, Nd, Sm, Gd, Tb, Dy, Ho and Yb and a fourth subcomponent consisting of an oxide including Si.

The main component of dielectric composition is a compound having a perovskite structure expressed by the above general formula; in the perovskite structure, Ba, Sr and Ca occupy an A site, and Ti and Zr occupy a B site.

In the general formula, “x” indicates Sr ratio in A site (Ba, Sr and Ca) of main component, “x” is 0.20≦x≦0.40, preferably 0.26≦x≦0.35. When “x” is too small, a dielectric loss and the capacitance change rate tend to deteriorate, while when too large, a specific permittivity tends to reduce and capacitance change rate at a lower temperature tends to deteriorate.

Also, in the general formula, “y” indicates Ca ratio in A site, “y” is 0≦y≦0.20, preferably 0≦y≦0.1, more preferably y is 0. When “y” is too large, capacitance change rate is flattened and tends to exceed a preferable range of the invention.

Also, in the general formula, “z” indicates Zr ratio in B site (Ti and Zr) of the main component, “z”, is 0≦z≦0.30, preferably 0≦z≦0.1, more preferably z is 0. When “z” is too large, specific permittivity reduces and the capacitance change rate is flattened and tends to exceed a preferable range of the invention.

Note that when y is 0 and z is 0, the above general formula is expressed by (Ba₁₋ₓSrₓ)ₘTiO₃ where “x” indicates a ratio of Ba and Sr. Even in this case, it is preferable that “x” is within the above mentioned range.

In the above general formula, “m” indicates molar ratio between an element occupying A site and an element occupying B site of the main component. “m” is 0.950 to 1.050, preferably 0.98 to 1.02.

Content of the first subcomponent (the oxide of Mg) with respect to 100 moles of the main component is 0.5 to 5 moles, preferably 1 to 4 moles, more preferably 1.5 to 3 moles in terms of an element. When the content of the first subcomponent is too small, the capacitance change rate tends to deteriorate and a high temperature load lifetime tends to be deteriorated, while when too large, it tends not to sinter densely.

The second subcomponent consists of at least one kind selected from oxides of Mn and Cr. The oxide of Mn is preferable in view of insulation resistance.

The content of the second subcomponent with respect to 100 moles of the main component is 0.05 to 2 moles, preferably 0.1 to 1 mole, more preferably 0.1 to 0.5 mole in terms of an element. When the content of the second subcomponent is too small, the insulation resistance tends to deteriorate while when too large, the high temperature load lifetime tends to be deteriorated.

R in the third subcomponent is at least one kind selected from Y, La Ce, Pr, Nd, Sm, Gd, Tb, Dy, Ho and Yb. Tb and Y are preferable and Y is more preferable in view of the high temperature accelerated lifetime and the capacitance change rate.

The content of the third subcomponent (oxide of R) with respect to 100 moles of the main component is 1 to 8 moles, preferably 2 to 7 moles, more preferably 3 to 5 moles in terms of an element. When the content of the third subcomponent is too small, the high temperature load lifetime tends to be deteriorated, while when too large, it tends not to sinter densely.

Content of the fourth subcomponent (the oxide including Si) with respect to 100 moles of the main component is 0.5 to 5 moles, preferably 1 to 4.5 moles, more preferably 2 to 3.5 moles in terms of the oxide. When the content of the fourth subcomponent is too small, the capacitance change rate tends to deteriorate, while when too large, it tends not to sinter densely.

The oxide including Si may be a composite oxide or a simple oxide, however, composite oxide is preferable and (Ba, Ca)ₙSiO₂₊ₙ (note that n=0.8 to 1.2) is more preferable. Further, “n” in (Ba, Ca)ₙSiO₂₊ₙ is preferably 0 to 2 and more preferably 0.8 to 1.2. When “n” is too small, it tends to react with barium titanate included in a main component and deteriorate the dielectric characteristic, while when too large, a melting point tends to be higher and a sinterablity tends to be deteriorated. Note that ratio of Ba and Ca included in the fourth subcomponent is optional and only either one may be included.

The dielectric ceramic composition according to the present embodiment preferably includes a fifth subcomponent in addition to the above main component and first to fourth subcomponents. The fifth subcomponent is an oxide of at least one kind of element selected from V, Mo, W, Ta and Nb, it is preferably the oxide of Nb and V, and more preferably the oxide of V in view of the high temperature accelerated lifetime.

The content of the fifth subcomponent with respect to 100 moles of the main component is 0 to 0.2 mole, preferably 0.01 to 0.07 mole, more preferably 0.02 to 0.06 mole in terms of each element. When the content of the fifth subcomponent is too large, the insulation resistance tends to be deteriorated.

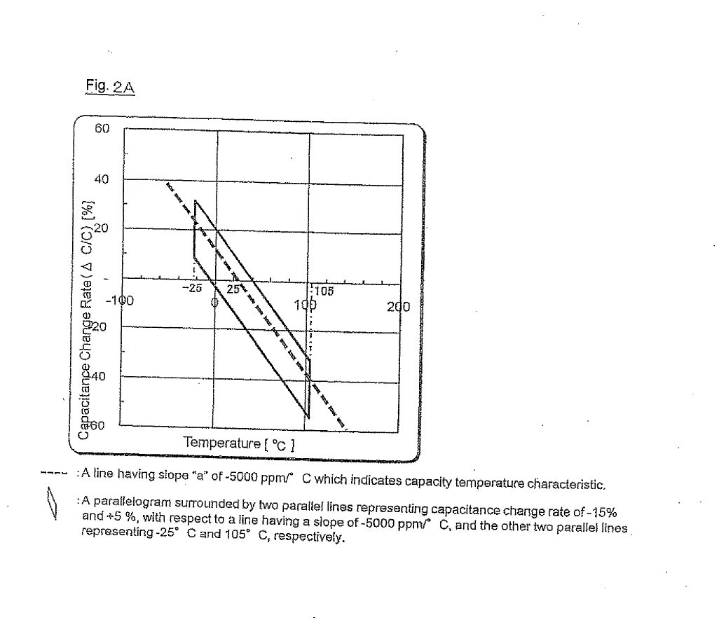

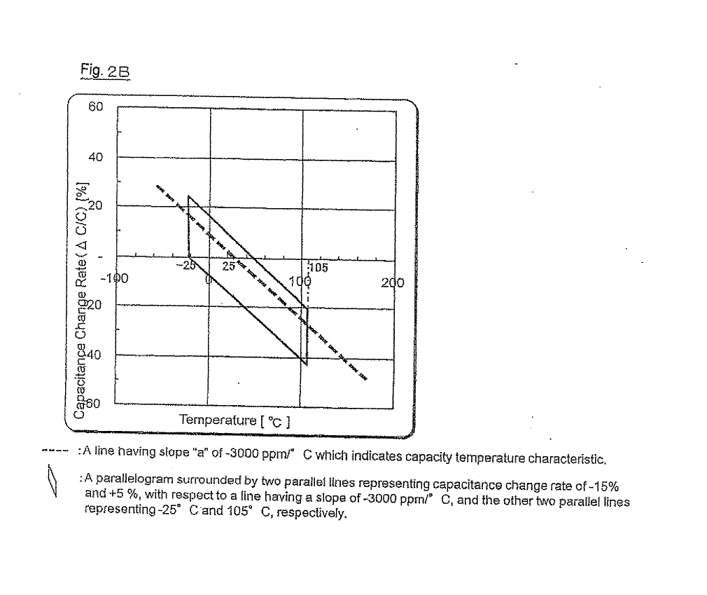

In the dielectric ceramic composition according to the present embodiment, as shown in FIGS. 2A and 2B, within a temperature range of −25 to 105° C., a capacitance change rate on the basis of capacitance at 25° C. is within the range of −15 to +5%, with respect to slope “a” which shows capacity temperature characteristic on the basis of capacitance at 25° C. Further, it is preferably within the range of −10 to 0%.

FIGS. 2A and 2B are graphs on which x-axis represents temperature and y-axis represents capacitance change rate, in the graphs, an area surrounded by two parallel lines representing −15% and +5% and two lines representing −25° C. and 105° C. (parallelogram) is a range of −15% to +5% with respect to a line showing the slope “a”.

Namely, when the slope “a” is −5000 ppm/° C., the area is the parallelogram shown in FIG. 2A, and when the slope “a” is −3000 ppm/° C., the area is the parallelogram shown in FIG. 2B.

The slope “a” is controlled in the range of −5500 to −1800 ppm/° C. Within the temperature range of −25° C. to 105° C., the capacitance change rate on the basis of capacitance at 25° C. can be set in the above range with respect to the line of the slope “a” controlled in the range.

In the present embodiment, the dielectric ceramic composition having the above composition further includes a sixth subcomponent,

The content of the sixth subcomponent (a composite oxide including Ba, Sr and Zr) is 5 to 30 moles in terms of the composite oxide with respect to 100 moles of the main component. By changing the content of the sixth subcomponent within the above range, the slope “a” can be easily changed while maintaining desirable characteristics. In addition, within the temperature range of −25° to 105° C., the capacitance change rate on the basis of capacitance at 25° C. can be set in the above range with respect to the line of the slope “a”,

As the composite oxide including Ba, Sr and Zr, a composite oxide expressed by a general formula of Ba₁₋ₐSrₐZrO₃ is preferable. In the above formula, “a” is preferably 0.20 to 0.40, more preferably 0.25 to 0.35.

In the present specification, each oxide or composite oxide comprising each component are expressed by a stoichiometric composition but oxidized state of each oxide or composite oxide can be out of this range. Note that the above ratio of each component, except for the fourth subcomponent, is obtained in terms of the element of the metal amount included in an oxide of each component. The fourth subcomponent is obtained in terms of the same to oxide or composite oxide.

Note that an average particle diameter of the sintered body obtained by sintering the above main component and subcomponents is preferably 0.2 to 1.5 μm, more preferably 0.2 to 0.8 μm.

The thickness of dielectric layer 2 is not particularly limited and can be an appropriate thickness in accordance with the use of the multilayer ceramic capacitor 1.

(Internal Electrode 3)

The conductive material included in the internal electrode 3 is not particularly limited and, since the constitutional material of the dielectric layer 2 show resistance to reduction, relatively inexpensive base metals can be used. As the base metal used as the conductive material, Ni or a Ni alloy is preferable. As the Ni alloy, an alloy of one or more kinds selected from Mn, Cr, Co and Al with Ni is preferable, and a content of Ni in the alloy is preferably 95 wt % or more. Note that the Ni or the Ni alloy may contain various trace components, such as P, by not more than 0.1 wt % or so. Further, the internal electrode 3 can be made by using the commercially available electrode paste. The thickness of the internal electrode layer 3 in the present embodiment can suitably determined in accordance with its use.

(External Electrode 4)

The conductive material included in the external electrode 4 is not particularly limited and an inexpensive material such as Ni, Cu or their alloys can be used in the present invention. The thickness of the external electrode 4 can suitably determined in accordance with its use.

(Manufacturing Method of Multilayer Ceramic Capacitor 1)

A multilayer ceramic capacitor 1 of the present embodiment is, as the same as the conventional multilayer ceramic capacitor, manufactured by producing a green chip by a normal printing method or a sheet method using a paste, firing the same, and then, printing or transferring the external electrode and firing the same. The manufacturing method will be concretely described below.

First, the dielectric material (dielectric ceramic composition powder) included in the dielectric layer paste is prepared and made into a paste to prepare the dielectric layer paste. The dielectric layer paste may be an organic type paste obtained by kneading the dielectric material and an organic vehicle, or a water-based paste.

As the dielectric material, the oxides of each component mentioned above, their mixtures and composite oxides may be used. Further, a mixture suitably selected from each compound that become the above mentioned oxides or composite oxides after firing, such as carbonates, oxalates, nitrates, hydroxides and organic metal compounds may be used. Content of each compound in dielectric material is determined so as to obtain the above dielectric ceramic composition after firing.

Further, as at least a part of material in the above each component; each oxide, composite oxides, and compounds that become each oxide or composite oxides after firing may be used as they are, or as roasted powder obtained by calcining the same.

Note that an average particle diameter of material of main component (Ba_{1-x-y}SrₓCa_{y})ₘ(Ti_{1-z}Zr_{z})O₃ in the dielectric material is preferably 0.15 to 0.7 μm, more preferably 0.2 to 0.5 μm. When the average particle diameter of the material is smaller than 0.15 μm, the average particle diameter of the sintered body becomes 0.2 μm or less, as a result, its specific permittivity is reduced and the capacitance change rate at higher temperature tends to deteriorate. Further, when the average particle diameter of the material is larger than 0.7 μm, the average particle diameter of the sintered body becomes 1.5 μm or more, as a result, the high temperature accelerated lifetime and the capacitance change rate at lower temperature tend to deteriorate.

The organic vehicle is obtained by dissolving a binder in an organic solvent. The binder used for the organic vehicle is not particularly limited and may be suitably selected from various normal binders such as ethyl cellulose, polyvinyl butyral and the like. Further, the organic solvent used is also not particularly limited and may be suitably selected from various organic solvents such as terpineol, butyl carbitol, acetone, toluene, and the like in accordance with the method of use, such as a printing method and a sheet method.

When preparing the dielectric layer paste as a water-based paste, a water-based vehicle is obtained by dissolving a water-soluble binder, dispersant, etc. in water, and the dielectric material may be kneaded. The water-soluble binder used for the water-based vehicle is not particularly limited, for example, polyvinyl alcohol, cellulose, and a water-soluble acrylic resin, etc. may be used.

An internal electrode layer paste is prepared by kneading a conductive material and the above mentioned organic vehicle. As the conductive material, the above variety of conductive metals and alloys, or a variety of oxides, organic metal compounds and resonates and the like which become the above conductive materials after firing.

An external electrode paste is prepared in the similar way as that of the above internal electrode layer paste.

A content of the organic vehicle in each paste is not particularly limited and may be a normal content of, for example, 1 to 5 wt % or so of the binder and 10 to 50 wt % or so of the solvent. Also, additives selected from a variety of dispersants, plasticizers, dielectrics and insulators, etc. may be included in each paste in accordance with the need. A total content thereof is preferably 10 wt % or less.

When using the printing method, the dielectric layer paste and internal electrode layer paste are printed on a substrate such as PET, and stacked, removed from the substrate then cut to a predetermined shape to obtain a green chip.

Further, when using the sheet method, the dielectric layer paste is used to form a green sheet, the internal electrode layer paste is printed thereon, then these are stacked and cut to a predetermined shape to obtain a green chip.

Before fixing, a binder removal treatment is performed to the green chip. The conditions of the binder removal, treatment are; a temperature rising rate is preferably 5 to 300° C./hour, a holding temperature is preferably 180 to 400° C. and a temperature holding time of preferably 0.5 to 24 hours. Further, binder removal atmosphere is air or reduced atmosphere.

Firing Atmosphere can be determined as an appropriate atmosphere in accordance with the conductive material included in internal electrode layer paste, however, when using Ni or Ni alloy or other base metal as the conductive material, the oxygen partial pressure in the firing atmosphere is preferably 10⁻¹⁴ to 10⁻¹⁰ MPa. If the oxygen partial pressure is less than that range, the conductive material of the internal electrode layers will be abnormally sintered and will end up causing disconnection in some cases. Further, if the oxygen partial pressure exceeds that range, the internal electrode layers tend to oxidize.

Further, the holding temperature at the time of firing is preferably 1000 to 1400° C. If the holding temperature is less than the above range, the densification becomes insufficient, while if it is over the above range, the breakage of the electrode due to the abnormal sintering of the internal electrode, deterioration of the capacity temperature characteristic due to the dispersion of the internal electrode layer materials, or a reduction of the dielectric ceramic composition tend to occur.

As the other firing conditions, a temperature rising rate is preferably 50 to 500° C./hour, a temperature holding time is preferably 0.5 to 8 hours, and a cooling rate is preferably 50 to 500° C./hour. Further, the firing atmosphere is preferably a reducing atmosphere.

It is preferable that the capacitor element body is annealed after firing in a reducing atmosphere. The annealing is a treatment for reoxidizing the dielectric layer. This remarkably extends the IR life, thereby the reliability is improved.

An oxygen partial pressure in the annealing atmosphere is preferably 10⁻⁹ to 10⁻⁵ MPa. Also, a holding temperature at the time of annealing is preferably 1100° C. or below, particularly 500 to 1100° C., a temperature holding time is preferably 0 to 20 hours.

To wet the N₂ gas or a mixed gas etc. in the above binder removal treatment, firing and annealing, for example a wetter etc. may be used. In this case, the water temperature is preferably 5 to 75° C. or so. The binder removal treatment, firing and annealing may be performed continuously or independently.

Thus obtained capacitor element body is end polished and the external electrode paste is printed on there and fired so as to form the external electrodes 4. Further, in accordance with the need, the external electrodes 4 are plated etc. to form covering layers.

Thus produced multilayer ceramic capacitor of the present embodiment is mounted on a printed circuit board by soldering etc. and used for various types of electronic equipments.

An embodiment of the present invention was explained above, but the present invention is not limited to the embodiment and may be variously embodied within the scope of the present invention.

For example, in the above embodiment, a multilayer ceramic capacitor was explained as an example of an electronic device according to the present invention, but the electronic device according to the present invention is not limited to a multilayer ceramic capacitor and may be any as far as it includes a dielectric layer having the above composition.

### EXAMPLES

Below, the present invention will be explained based on further detailed examples; however, the present invention is not limited to the examples.

### Example 1

First, as material of a main component, (Ba_{1-x-y}SrₓCa_{y})ₘ(Ti_{1-z}Zr_{z})O₃ having an average particle diameter of 0.36 μm is prepared. Also, as material of subcomponents, MgCO₃ (a first subcomponent), MnO (a second subcomponent), Y₂O₃ (a third subcomponent), BaCaSiO₃ (a fourth subcomponent), V₂O₅ (a fifth subcomponent) and BaSrZrO₃ (a sixth subcomponent) were prepared. The materials of the main component and the subcomponents prepared in the above were weighed so that the amounts shown in Tables 1 and 3 and then mixed by a ball mill. The obtained mixed powder was calcined at 1200° C. to obtain a calcined powder having an average particle diameter of 0.4 μm. Next, the obtained calcined powder was wet-pulverized by a ball mill for 15 hours, and then dried to obtain a dielectric material. Note that, after firing, MgCO₃ will be included as MgO in dielectric ceramic composition.

Next, 100 parts by weight of the obtained dielectric material, 10 parts by weight of polyvinyl butyral, 5 parts by weight of dibutyl phthalate (DBP) as plasticizer, and 100 parts by weight of alcohol as solvent were mixed by ball mill and made into a paste so as to obtain a dielectric layer paste.

Next, 45 parts by weight of Ni particles, 52 parts by weight of terpineol and 3 parts by weight of ethyl cellulose were kneaded by a triple roll and made into a slurry so as to obtain an internal electrode layer paste.

By using the obtained dielectric layer paste, a green sheet having a thickness of 10 μm after drying was formed on a PET film. Next, by using the internal electrode layer paste, the electrode layer was printed on the green sheet by a predetermined pattern and then, the green sheet was removed from the PET film so as to obtain the green sheet having electrode layer. Next, a plurality of green sheets having electrode layer were stacked and adhered by pressure to obtain the green multilayer body. The green multilayer body was cut into a predetermined size to obtain a green chip.

Next, the obtained green chip was subjected to a binder removal treatment, firing and annealing under the conditions described in below so as to obtain a multilayer ceramic fired body.

The binder removal treatment condition was a temperature rising rate of 25° C./hour, holding temperature of 250° C., temperature holding time of 8 hours and atmosphere of air.

The firing condition was a temperature rising rate of 200° C./hour, a holding temperature of 1300° C., a temperature holding time of 2 hours, a temperature cooling rate of 200° C./hour and an atmosphere of a wet mixed gas of N₂ and H₂ (oxygen pressure of 10⁻¹² MPa).

The annealing condition was a temperature rising rate of 200° C./hour, a holding temperature of 1100° C., a temperature holding time of 2 hours, a temperature cooling rate of 200° C./hour and an atmosphere of a wet N₂ gas (oxygen pressure of 10⁻⁷ MPa).

Next, after polishing an end surface of the obtained multilayer ceramic sintered body by sand blast, In—Ga was coated as external electrodes and the sample of the multilayer ceramic capacitor shown in FIG. 1 was obtained. A size of the obtained capacitor sample was 3.2 mm×1.6 mm×3.2 mm, a thickness of dielectric layer was 8 μm, a thickness of internal electrode layer was 1.5 μm and the number of dielectric layers between internal electrode layers was 4.

For the obtained each capacitor sample, a specific permittivity (∈s), a dielectric loss (tan δ), insulation resistance (IR), a capacitance change rate, a high temperature accelerated lifetime (HALT) and an average particle diameter of the sintered body were measured by the methods shown below.

(Specific Permittivity ∈s)

The specific permittivity ∈s was calculated from a capacitance of the obtained capacitor sample measured at a reference temperature of 25° C. with a digital. LCR meter (4274A made by YHP) under a condition of a frequency of 1 kHz and an input signal level (measurement voltage) of 1.0 Vrms. Higher specific permittivity is preferable, and in the present example, samples in which specific permittivity was 500 or higher were determined as good. The results are shown in Tables 2 and 4.

(Dielectric Loss (tan δ))

The dielectric loss (tan δ) was measured from the obtained capacitor sample at a reference temperature of 25° C. with a digital LCR meter (4274A made by YHP) under a condition of a frequency of 1 kHz and an input signal level (measurement voltage) of 1.0 Vrms. Lower dielectric loss is preferable, and in the present example, samples in which dielectric loss was 3% or less were determined as good. The results are shown in Tables 2 and 4.

(Insulation Resistance (IR))

The insulation resistance (IR) was measured when a capacitor sample was impressed with DC100V for 60 seconds at 25° C. by insulation resistance meter (R8340 made by Advantest). Higher insulation resistance is preferable, and in the present example, samples in which insulation resistance was 1×10¹⁰ MΩ or higher were determined as good. The results are shown in Tables 2 and 4.

(Capacitance Change Rate (TC))

The capacitance was measured in a temperature range of −25 to 105° C. with a digital LCR meter (4284A made by YHP) under a condition of a frequency of 1 kHz and an input signal level (measured voltage) of 1 Vrms. Then, capacitance change rate (unit: %) was calculated at −25° C. and 105° C., with respect to the capacitance at reference temperature of 25° C., and a slope “a” of capacitance characteristic was calculated. In the present example, samples in which slope “a” was in the range of −5500 to −1800 ppm/° C. was determined as good. The results are shown in Tables 2 and 4.

(High Temperature Load Lifetime (High Temperature Accelerated Lifetime: HALT))

For the capacitor samples, the life time was measured while applying the direct voltage under the electric field of 40 V/μm at 200° C., and thereby the high temperature load lifetime was evaluated. In the present example, the lifetime was defined as the time from the beginning of the voltage application until the insulation resistance drops by one digit. Also, this high temperature load lifetime evaluation was performed to 10 capacitor samples. In the present example, slope “a”3.1 hours or longer was determined as good. The results are shown in Tables 2 and 4.

(Average Particle Diameter of Sintered Body)

In order to measure an average particle diameter of dielectric particles in sintered body, the obtained capacitor samples were cut at a surface vertical to internal electrode, then said cut surface was polished. After chemical etching the polished surface, the surface was observed with a scanning electron microscope (SEM) and an average particle diameter was measured based on the code method by assuming that the particles have spherical shapes. The results are shown in Tables 2 and 4.

TABLE 1

| | | | | | | | contents of subcomponents with | | | | | |
|---|---|---|---|---|---|---|---|---|---|---|---|---|
| | | | | | | | respect to 100 moles of main component [mol] | | | | | |
| | | average | compositions of | | | | | | 3rd | | | |
| | | particle | main component | | | | | 2nd | subcom- | 4th | 5th | 6th |
| | | diameter | (Ba_{1-x-y}SrₓCa_{y})ₘ(Ti_{1-z}Zr_{z})O₃ | | | | 1st | subcom- | ponent | subcomponent | subcomponent | subcomponent |
| | | of main | | | | m | subcom- | ponent | (rare | 0.5 to 5 | (V, Mo, W, | 0 to 30 |
| | | compo- | x | y | z | 0.950 | ponent | (Mn, Cr) | earth) | kind of 4th | Ta, Nb) | kind of 6th |
| | item | nent | 0.20 to | 0 to | 0 to | to | (Mg) | 0.05 to 2 | 1 to 8 | subcom- | 0 to 0.2 | subcom- |
| No. | range | [mm] | 0.40 | 0.20 | 0.30 | 1.050 | 0.5 to 5 | A | R | ponent | D | ponent |

| | | | | | | | | | | | | | | | | |
|---|---|---|---|---|---|---|---|---|---|---|---|---|---|---|---|---|
| 1 | 0.35 | 0.3 | 0 | 0 | 1 | 2 | Mn | 0.2 | Y | 4 | BaCaSiO3 | 3 | V | 0.06 | BaSrZrO3 | 15 |
| 2* | 0.35 | 0.1 | 0 | 0 | 1 | 2 | Mn | 0.2 | Y | 4 | BaCaSiO3 | 3 | V | 0.06 | BaSrZrO3 | 15 |
| 3 | 0.35 | 0.2 | 0 | 0 | 1 | 2 | Mn | 0.2 | Y | 4 | BaCaSiO3 | 3 | V | 0.06 | BaSrZrO3 | 15 |
| 4 | 0.35 | 0.4 | 0 | 0 | 1 | 2 | Mn | 0.2 | Y | 4 | BaCaSiO3 | 3 | V | 0.06 | BaSrZrO3 | 15 |
| 5* | 0.35 | 0.5 | 0 | 0 | 1 | 2 | Mn | 0.2 | Y | 4 | BaCaSiO3 | 3 | V | 0.06 | BaSrZrO3 | 15 |
| 6* | 0.35 | 0.21 | 0.3 | 0 | 1 | 2 | Mn | 0.2 | Y | 4 | BaCaSiO3 | 3 | V | 0.06 | BaSrZrO3 | 15 |
| 7 | 0.35 | 0.24 | 0.2 | 0 | 1 | 2 | Mn | 0.2 | Y | 4 | BaCaSiO3 | 3 | V | 0.06 | BaSrZrO3 | 15 |
| 8 | 0.35 | 0.25 | 0.15 | 0.2 | 1 | 2 | Mn | 0.2 | Y | 4 | BaCaSiO3 | 3 | V | 0.06 | BaSrZrO3 | 15 |
| 9 | 0.35 | 0.3 | 0 | 0.3 | 1 | 2 | Mn | 0.2 | Y | 4 | BaCaSiO3 | 3 | V | 0.06 | BaSrZrO3 | 15 |
| 10* | 0.35 | 0.3 | 0 | 0.4 | 1 | 2 | Mn | 0.2 | Y | 4 | BaCaSiO3 | 3 | V | 0.06 | BaSrZrO3 | 15 |
| 11* | 0.35 | 0.3 | 0 | 0 | 0.9 | 2 | Mn | 0.2 | Y | 4 | BaCaSiO3 | 3 | V | 0.06 | BaSrZrO3 | 15 |
| 12 | 0.35 | 0.3 | 0 | 0 | 0.95 | 2 | Mn | 0.2 | Y | 4 | BaCaSiO3 | 3 | V | 0.06 | BaSrZrO3 | 15 |
| 13 | 0.35 | 0.3 | 0 | 0 | 1.05 | 2 | Mn | 0.2 | Y | 4 | BaCaSiO3 | 3 | V | 0.06 | BaSrZrO3 | 15 |
| 14* | 0.35 | 0.3 | 0 | 0 | 1.1 | 2 | Mn | 0.2 | Y | 4 | BaCaSiO3 | 3 | V | 0.06 | BaSrZrO3 | 15 |
| 15* | 0.35 | 0.3 | 0 | 0 | 1 | 0.3 | Mn | 0.2 | Y | 4 | BaCaSiO3 | 3 | V | 0.06 | BaSr2rO3 | 15 |
| 16 | 0.35 | 0.3 | 0 | 0 | 1 | 0.5 | Mn | 0.2 | Y | 4 | BaCaSiO3 | 3 | V | 0.06 | BaSrZrO3 | 15 |
| 17 | 0.35 | 0.3 | 0 | 0 | 1 | 5 | Mn | 0.2 | Y | 4 | BaCaSiO3 | 3 | V | 0.06 | BaSrZrO3 | 15 |
| 18* | 0.35 | 0.3 | 0 | 0 | 1 | 8 | Mn | 0.2 | Y | 4 | BaCaSiO3 | 3 | V | 0.06 | BaSrZrO3 | 15 |
| 19* | 0.35 | 0.3 | 0 | 0 | 1 | 2 | Mn | 0.02 | Y | 4 | BaCaSiO3 | 3 | V | 0.06 | BaSrZrO3 | 15 |
| 20 | 0.35 | 0.3 | 0 | 0 | 1 | 2 | Mn | 0.05 | Y | 4 | BaCaSiO3 | 3 | V | 0.06 | BaSrZrO3 | 15 |
| 21 | 0.35 | 0.3 | 0 | 0 | 1 | 2 | Mn | 2 | Y | 4 | BaCaSiO3 | 3 | V | 0.06 | BaSrZrO3 | 15 |
| 22* | 0.35 | 0.3 | 0 | 0 | 1 | 2 | Mn | 3 | Y | 4 | BaCaSiO3 | 3 | V | 0.06 | BaSrZrO3 | 15 |
| 23 | 0.35 | 0.3 | 0 | 0 | 1 | 2 | Cr | 0.2 | Y | 4 | BaCaSiO3 | 3 | V | 0.06 | BaSrZrO3 | 15 |

“*” indicates a sample which is without the range of the present invention
Italicized numerical value is without the range of the invention.

TABLE 2

| | | average | | | | capacity temperature | high | |
|---|---|---|---|---|---|---|---|---|
| | | particle | initial characteristic | | | change rate | temperature | |
| | | diameter | specific | dielectric | insulation | (TC) [%] | accelerated | |
| | | of | permittivity | loss | resistance | −25° C.~105° C. | lifetime | |
| | | sintered | (es) | (tanδ) [%] | (IR) [MΩ] | a: −1800 ppm/° C. | (HALT) [b] | |
| | item | body | 500 | 3 | 1.0E+10 | to | 3.1 | good or |
| No. | range | [mm] | or more | or less | or more | −5500 ppm/° C. | or more | bad |

| 1 | 0.4 | 875 | 1.1 | 4.2E+11 | −3,100 | 52 | good |
|---|---|---|---|---|---|---|---|
| 2* | 0.5 | 2188 | 5.1 | 2.2E+11 | −10,000 | 3.3 | bad |
| 3 | 0.4 | 1125 | 1.4 | 6.5E+11 | −3,150 | 48 | good |
| 4 | 0.6 | 713 | 0.77 | 4.8E+11 | −2,900 | 25 | good |
| 5* | 0.4 | 480 | 0.45 | 4.5E+11 | −8,000 | 12 | bad |
| 6* | 0.6 | 631 | 1.2 | 5.4E+11 | −5,800 | 2.1 | bad |
| 7 | 0.4 | 788 | 0.95 | 2.8E+11 | −3,150 | 19 | good |
| 8 | 0.4 | 719 | 1.1 | 7.6E+11 | −3,200 | 24 | good |
| 9 | 0.5 | 694 | 0.86 | 9.8E+11 | −3,200 | 35 | good |
| 10* | 0.4 | 594 | 0.75 | 4.6E+11 | −900 | 43 | bad |
| 11* | — | Do Not Sinter Densely | | | | | bad |
| 12 | 0.6 | 856 | 0.91 | 5.9E+11 | −3,250 | 31 | good |
| 13 | 0.4 | 888 | 1.04 | 4.1E+11 | −3,100 | 29 | good |
| 14* | — | Do Not Sinter Densely | | | | | bad |
| 15* | 3.1 | 1750 | 2.5 | 4.1E+10 | −7,400 | 0.11 | bad |
| 16 | 0.8 | 969 | 1.04 | 6.9E+11 | −3,200 | 49 | good |
| 17 | 0.4 | 656 | 1.4 | 8.8E+11 | −3,100 | 34 | good |
| 18* | — | Do Not Sinter Densely | | | | | bad |
| 19* | 0.5 | 944 | 2.8 | 6.4E+08 | −3,100 | 3.2 | bad |
| 20 | 0.4 | 875 | 1.1 | 2.1E+11 | −3,000 | 39 | good |
| 21 | 0.5 | 863 | 1.45 | 7.6E+11 | −3,100 | 13 | good |
| 22* | 0.8 | 825 | 1.3 | 6.7E+11 | −3,400 | 0.05 | bad |
| 23 | 0.4 | 869 | 1.14 | 6.3E+11 | −3,000 | 29 | good |

“*” indicates a sample which is without the range of the present invention
Italicized numerical value is without the range of the invention.

TABLE 3

| | | | | | | | contents of subcomponents with | | | | | |
|---|---|---|---|---|---|---|---|---|---|---|---|---|
| | | | | | | | respect to 100 moles of main component [mol] | | | | | |
| | | average | compositions of | | | | | | 3rd | | | |
| | | particle | main component | | | | | 2nd | subcom- | 4th | 5th | 6th |
| | | diameter | (Ba_{1-x-y}SrₓCa_{y})ₘ(Ti_{1-z}Zr_{z})O₃ | | | | 1st | subcom- | ponent | subcomponent | subcomponent | subcomponent |
| | | of main | | | | m | subcom- | ponent | (rare | 0.5 to 5 | (V, Mo, W, | 0 to 30 |
| | | compo- | x | y | z | 0.950 | ponent | (Mn, Cr) | earth) | kind of 4th | Ta, Nb) | kind of 6th |
| | item | nent | 0.20 to | 0 to | 0 to | to | (Mg) | 0.05 to 2 | 1 to 8 | subcom- | 0 to 0.2 | subcom- |
| No. | range | [mm] | 0.40 | 0.20 | 0.30 | 1.050 | 0.5 to 5 | A | R | ponent | D | ponent |

| | | | | | | | | | | | | | | | | |
|---|---|---|---|---|---|---|---|---|---|---|---|---|---|---|---|---|
| 24* | 0.35 | 0.3 | 0 | 0 | 1 | 2 | Mn | 0.2 | Y | 0.2 | BsCaSiO3 | 3 | V | 0.06 | BaSrZrO3 | 15 |
| 25 | 0.35 | 0.3 | 0 | 0 | 1 | 2 | Mn | 0.2 | Y | 1 | BaCaSiO3 | 3 | V | 0.06 | BaSrZrO3 | 15 |
| 26 | 0.35 | 0.3 | 0 | 0 | 1 | 2 | Mn | 0.2 | Y | 8 | BaCaSiO3 | 3 | V | 0.06 | BaSrZrO3 | 15 |
| 27* | 0.35 | 0.3 | 0 | 0 | 1 | 2 | Mn | 0.2 | Y | 12 | BaCaSiO3 | 3 | V | 0.06 | BaSrZrO3 | 15 |
| 28 | 0.35 | 0.3 | 0 | 0 | 1 | 2 | Mn | 0.2 | La | 4 | BaCaSiO3 | 3 | V | 0.06 | BaSrZrO3 | 15 |
| 29 | 0.35 | 0.3 | 0 | 0 | 1 | 2 | Mn | 0.2 | Ce | 4 | BaCaSiO3 | 3 | V | 0.06 | BaSrZrO3 | 15 |
| 30 | 0.35 | 0.3 | 0 | 0 | 1 | 2 | Mn | 0.2 | Pr | 4 | BaCaSiO3 | 3 | V | 0.06 | BaSrZrO3 | 15 |
| 31 | 0.35 | 0.3 | 0 | 0 | 1 | 2 | Mn | 0.2 | Nd | 4 | BaCaSiO3 | 3 | V | 0.06 | BaSrZrO3 | 15 |
| 32 | 0.35 | 0.3 | 0 | 0 | 1 | 2 | Mn | 0.2 | Sm | 4 | BaCaSiO3 | 3 | V | 0.06 | BaSrZrO3 | 15 |
| 33 | 0.35 | 0.3 | 0 | 0 | 1 | 2 | Mn | 0.2 | Gd | 4 | BaCaSiO3 | 3 | V | 0.06 | BaSrZrO3 | 15 |
| 34 | 0.35 | 0.3 | 0 | 0 | 1 | 2 | Mn | 0.2 | Tb | 4 | BaCaSiO3 | 3 | V | 0.06 | BaSrZrO3 | 15 |
| 35 | 0.35 | 0.3 | 0 | 0 | 1 | 2 | Mn | 0.2 | Dy | 4 | BaCaSiO3 | 3 | V | 0.06 | BaSrZrO3 | 15 |
| 36 | 0.35 | 0.3 | 0 | 0 | 1 | 2 | Mn | 0.2 | Ho | 4 | BaCaSiO3 | 3 | V | 0.06 | BaSrZrO3 | 15 |
| 37 | 0.35 | 0.3 | 0 | 0 | 1 | 2 | Mn | 0.2 | Yb | 4 | BaCaSiO3 | 3 | V | 0.06 | BaSrZrO3 | 15 |
| 38* | 0.35 | 0.3 | 0 | 0 | 1 | 2 | Mn | 0.2 | Y | 4 | BaCaSiO3 | 0 | V | 0.06 | BaSrZrO3 | 15 |
| 39 | 0.35 | 0.3 | 0 | 0 | 1 | 2 | Mn | 0.2 | Y | 4 | BaCaSiO3 | 0.5 | V | 0.06 | BaSrZrO3 | 15 |
| 40 | 0.35 | 0.3 | 0 | 0 | 1 | 2 | Mn | 0.2 | Y | 4 | BaCaSiO3 | 5 | V | 0.06 | BaSrZrO3 | 15 |
| 41* | 0.35 | 0.3 | 0 | 0 | 1 | 2 | Mn | 0.2 | Y | 4 | BaCaSiO3 | 8 | V | 0.06 | BaSrZrO3 | 15 |
| 42 | 0.35 | 0.3 | 0 | 0 | 1 | 2 | Mn | 0.2 | Y | 4 | BaSiO3 | 3 | V | 0.06 | BaSrZrO3 | 15 |
| 43 | 0.35 | 0.3 | 0 | 0 | 1 | 2 | Mn | 0.2 | Y | 4 | CaSiO3 | 3 | V | 0.06 | BaSrZrO3 | 15 |
| 44 | 0.35 | 0.3 | 0 | 0 | 1 | 2 | Mn | 0.2 | Y | 4 | SiO2 | 3 | V | 0.06 | BaSrZrO3 | 15 |
| 45 | 0.35 | 0.3 | 0 | 0 | 1 | 2 | Mn | 0.2 | Y | 4 | BaCaSiO3 | 3 | V | 0 | BaSrZrO3 | 15 |
| 46 | 0.35 | 0.3 | 0 | 0 | 1 | 2 | Mn | 0.2 | Y | 4 | BaCaSiO3 | 3 | V | 0.2 | BaSrZrO3 | 15 |
| 47** | 0.35 | 0.3 | 0 | 0 | 1 | 2 | Mn | 0.2 | Y | 4 | BaCaSiO3 | 3 | V | 0.3 | BaSrZrO3 | 15 |
| 48 | 0.35 | 0.3 | 0 | 0 | 1 | 2 | Mn | 0.2 | Y | 4 | BaCaSiO3 | 3 | Mo | 0.06 | BaSrZrO3 | 15 |
| 49 | 0.35 | 0.3 | 0 | 0 | 1 | 2 | Mn | 0.2 | Y | 4 | BaCaSiO3 | 3 | W | 0.06 | BaSrZrO3 | 15 |
| 50 | 0.35 | 0.3 | 0 | 0 | 1 | 2 | Mn | 0.2 | Y | 4 | BaCaSiO3 | 3 | Ta | 0.06 | BaSrZrO3 | 15 |
| 51 | 0.35 | 0.3 | 0 | 0 | 1 | 2 | Mn | 0.2 | Y | 4 | BaCaSiO3 | 3 | Nb | 0.06 | BaSrZrO3 | 15 |
| 52 | 0.15 | 0.3 | 0 | 0 | 1 | 2 | Mn | 0.2 | Y | 4 | BaCaSi03 | 3 | V | 0.06 | BaSrZrO3 | 15 |
| 53 | 0.7 | 0.3 | 0 | 0 | 1 | 2 | Mn | 0.2 | Y | 4 | BaCaSiO3 | 3 | V | 0.06 | BaSrZrO3 | 15 |

“*” indicates a sample which is without the range of the present invention
“**” indicates a sample which is without the preferable range of the present invention
Italicized numerical value is without the range of the invention.

TABLE 4

| | | average | | | | capacity temperature | high | |
|---|---|---|---|---|---|---|---|---|
| | | particle | initial characteristic | | | change rate | temperature | |
| | | diameter | specific | dielectric | insulation | (TC) [%] | accelerated | |
| | | of | permittivity | loss | resistance | −25° C.~105° C. | lifetime | |
| | | sintered | (es) | (tanδ) [%] | (IR) [MΩ] | a: −1800 ppm/° C. | (HALT) [b] | |
| | item | body | 500 | 3 | 1.0E+10 | to | 3.1 | good or |
| No. | range | [mm] | or more | or less | or more | −5500 ppm/° C. | or more | bad |

| 24* | 1.1 | 925 | 1.04 | 1.2E+11 | −3,150 | 0.08 | bad |
|---|---|---|---|---|---|---|---|
| 25 | 0.4 | 944 | 0.6 | 5.5E+11 | −3,050 | 22 | good |
| 26 | 0.4 | 775 | 1.3 | 8.5E+10 | −2,900 | 38 | good |
| 27* | — | Do Not Sinter Densely | | | | | bad |
| 28 | 0.9 | 1219 | 1.1 | 4.5E+10 | −3,100 | 9.8 | good |
| 29 | 0.6 | 1150 | 1.3 | 4.4E+10 | −3,100 | 11.2 | good |
| 30 | 0.7 | 1000 | 1.23 | 9.8E+10 | −3,050 | 15 | good |
| 31 | 0.5 | 994 | 1.06 | 7.9E+10 | −3,000 | 22 | good |
| 32 | 0.5 | 963 | 0.92 | 2.5E+11 | −3,050 | 34 | good |
| 33 | 0.4 | 875 | 1.02 | 5.6E+11 | −3,000 | 44 | good |
| 34 | 0.4 | 875 | 0.69 | 4.2E+11 | −2,950 | 50 | good |
| 35 | 0.5 | 875 | 0.83 | 6.8E+11 | −2,800 | 45 | good |
| 36 | 0.4 | 875 | 0.88 | 2.4E+11 | −2,900 | 41 | good |
| 37 | 0.3 | 863 | 0.96 | 4.3E+11 | −2,850 | 7.6 | good |
| 38* | 1.1 | 1281 | 2.6 | 2.3E+11 | −8,300 | 5.6 | bad |
| 39 | 0.4 | 969 | 1.23 | 3.3E+11 | −2,800 | 25 | good |
| 40 | 0.4 | 756 | 1.12 | 7.6E+10 | −2,800 | 22 | good |
| 41* | — | Do Not Sinter Densely | | | | | bad |
| 42 | 0.4 | 906 | 1.15 | 3.2E+11 | −3,000 | 19 | good |
| 43 | 0.4 | 869 | 0.95 | 5.2E+10 | −2,950 | 10 | good |
| 44 | 0.5 | 881 | 0.35 | 6.3E+11 | −3,100 | 19 | good |
| 45 | 0.6 | 875 | 0.65 | 9.2E+11 | −3,000 | 18 | good |
| 46 | 0.4 | 875 | 0.94 | 2.1E+10 | −2,950 | 65 | good |
| 47** | 0.4 | 856 | 2.9 | 1.4E+09 | −3,050 | 84 | bad |
| 48 | 0.3 | 800 | 0.93 | 7.8E+10 | −3,000 | 34 | good |
| 49 | 0.3 | 806 | 0.88 | 8.9E+10 | −3,000 | 33 | good |
| 50 | 0.4 | 863 | 0.87 | 4.4E+11 | −3,100 | 31 | good |
| 51 | 0.4 | 881 | 0.89 | 4.5E+11 | −3,050 | 19 | good |
| 52 | 0.25 | 750 | 0.79 | 5.2E+11 | −3,000 | 67 | good |
| 53 | 1.2 | 938 | 0.93 | 5.1E+11 | −3,200 | 9.5 | good |

“*” indicates a sample which is without the range of the present invention
“**” indicates a sample which is without the preferable range of the present invention
Italicized numerical value is without the range of the invention.

(Effect of “x” (Ratio of Sr in A Site) (Samples 1 to 5))

As shown in Tables 1 and 2, in the samples 1, 3 and 4, not only “x” but “y”, “z”, “m” and the contents of the subcomponents with respect to the main component were within the range of the present invention. These samples 1, 3 and 4 showed that dielectric loss was good and the slope “a” was within the range of the present invention, when compared to the sample 2 in which “x” was smaller than the range of the present invention. Further, samples 1, 3 and 4 showed that specific permittivity was good and the slope “a” was within the range of the present invention, respectively, when compared to the sample 5 in which “x” was larger than the range of the present invention.

(Effect of “y” (Ratio of Ca in A Site) (Samples 1 and 6 to 8))

As shown in Tables 1 and 2, in the samples 1, 7 and 8, not only “y” but “x”, “z”, “m” and the contents of the subcomponents with respect to the main component were within the range of the present invention. These samples 1, 7 and 8 showed that specific permittivity was good and the slope “a” was within the range of the present invention, when compared to the sample 6 in which “y” was larger than the range of the present invention.

(Effect of “z” (Ratio of Zr in B Site) (Samples 1 and 8 to 10))

As shown in Tables 1 and 2, in samples 1, 8 and 9, not only “z” but “x”, “y”, “m” and the contents of the subcomponents with respect to the main component were within the range of the present invention. These samples 1, 8 and 9 showed that specific permittivity was good and the slope “a” was within the range of the present invention, when compared to the sample 10 in which “z” was larger than the range of the present invention.

(Effect of “m” (Ratio of A site and B Site) (Samples 1 and 11 to 14))

As shown in Tables 1 and 2, in the samples 1, 12 and 13, not only “m” but the composition of the main component and the contents of the subcomponents with respect to the main component were within the range of the present invention. These samples 1, 12 and 13 showed good sintering, when compared to the samples 11 and 14 in which “m” was out of the range of the invention.

### (Effect of the First Subcomponent (Samples 1 and 15 to 18))

As shown in Tables 1 and 2, in the samples 1, 16 and 17, not only the contents of the first subcomponent (MgO) with respect to 100 moles of the main component but the composition of the main component and the contents of the other subcomponents were within the range of the invention. These samples 1, 16 and 17 showed good high temperature load lifetime and the slope “a” within the range of the present invention, when compared to the sample 15 in which the content of MgO was smaller than the range of the present invention. Further, the samples 1, 16 and 17 showed good sintering when compared to the sample 18 in which the content of the first subcomponent was larger than the range of the present invention.

### (Effect of the Second Subcomponent (Samples 1 and 19 to 23))

As shown in Tables 1 and 2, in the samples 1, 20 and 21, not only the content of the second subcomponent (MnO) with respect to 100 moles of the main component but the composition of the main component and the contents of the other subcomponents were within the range of the invention. These samples 1, 20 and 21 showed good insulation resistance, when compared to the sample 19 in which content of the second subcomponent was smaller than the range of the present invention. Further, the samples 1, 20 and 21 showed good high temperature load lifetime, when compared to the sample 22 in which content of the second subcomponent was larger than the range of the present invention.

Also, by referring to the sample 23, when Cr was used instead of Mn as the second subcomponent, it was confirmed that the same effects could be obtained as that of Mn.

### (Effect of the Third Subcomponent (Oxide of R) (Samples 1 and 24 to 37))

As shown in Tables 3 and 4, in the samples 1, 25 and 26, not only the content of the third subcomponent (Y₂O₃) with respect to 100 moles of the main component but the composition of the main component and the contents of the other subcomponents were within the range of the invention. These samples 1, 25 and 26 showed good high temperature load lifetime, when compared to the sample 24 in which content of the third subcomponent was smaller than the range of the present invention. Further, the samples 1, 25 and 26 showed good sintering when compared to the sample 18 in which content of the second subcomponent was larger than the range of the present invention.

Also, by referring to the samples 28 to 37, when La Ce, Pr, Nd, Sm, Gd, Tb, Dy, Ho and Yb were used instead of Y as R, it was confirmed that the same effects could be obtained as that of Y.

### (Effect of the Fourth Subcomponent (Oxide Including Si) (Samples 1 and 38 to 44)

As shown in Tables 3 and 4, in the samples 1, 39 and 40, not only the contents of the fourth subcomponent (BaCaSiO₃) with respect to 100 moles of the main component but the composition of the main component and the contents of the other subcomponents were within the range of the invention. These samples 1, 39 and 40 showed good dielectric loss and the slope “a” was within the range of the present invention, when compared to the sample 38 in which content of the fourth subcomponent was smaller than the range of the present invention. Further, the samples 1, 39 and 40 showed good sintering when compared to the sample 41 in which contents of the fourth subcomponent was larger than the range of the present invention.

Also, by referring to the samples 42 to 44, when BaSiO₃, CaSiO₃, SiO₂ were used instead of BaCaSiO₃ as the fourth subcomponent, it was confirmed that the same effects could be obtained as that of BaCaSiO₃.

### (Effect of the Fifth Subcomponent (Samples 1 and 45 to 51))

As shown in Tables 3 and 4, in the samples 1, 45 and 46, the contents of the fifth subcomponent (V₂O₅) with respect to 100 moles of the main component, composition of the main component and contents of the other subcomponents were within the range of the invention. These samples 1, 45 and 46 showed good dielectric loss and insulation resistance when compared to the sample 47 in which contents of V₂O₅ was larger than the preferable range of the present invention.

Further, by referring to the samples 48 to 51, when Mo, W, Ta and Nb were used instead of V as the fifth subcomponent, it was confirmed that the same effects could be obtained as that of V.

### Example 2

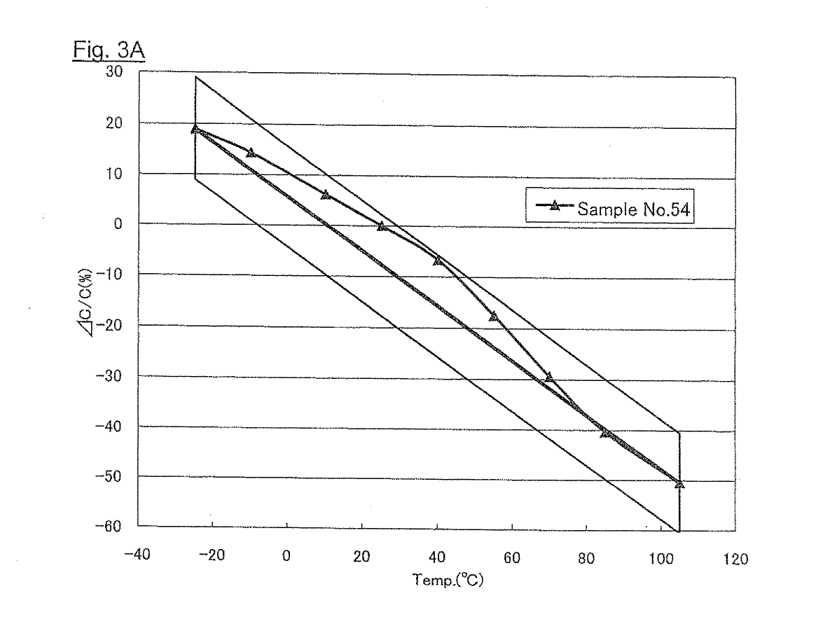

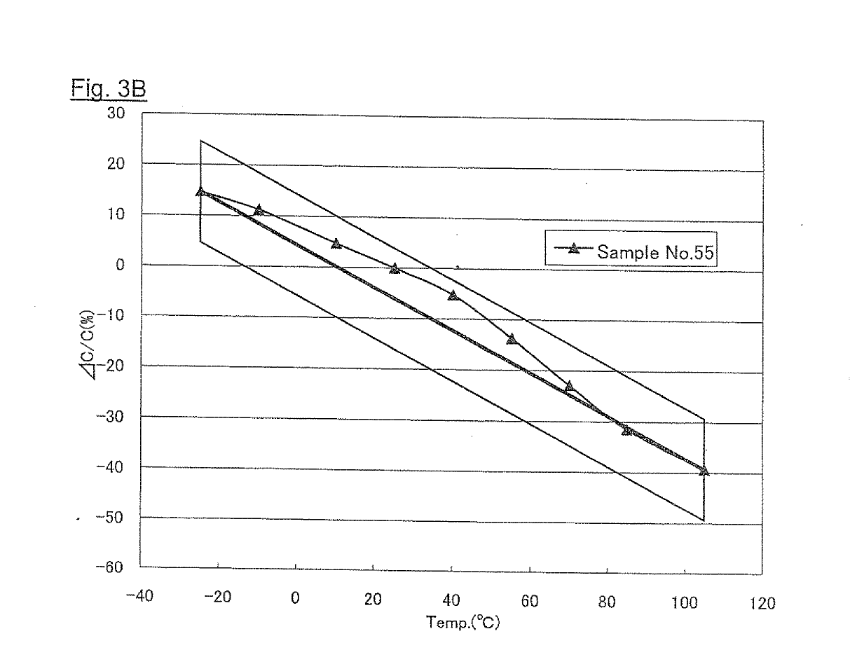

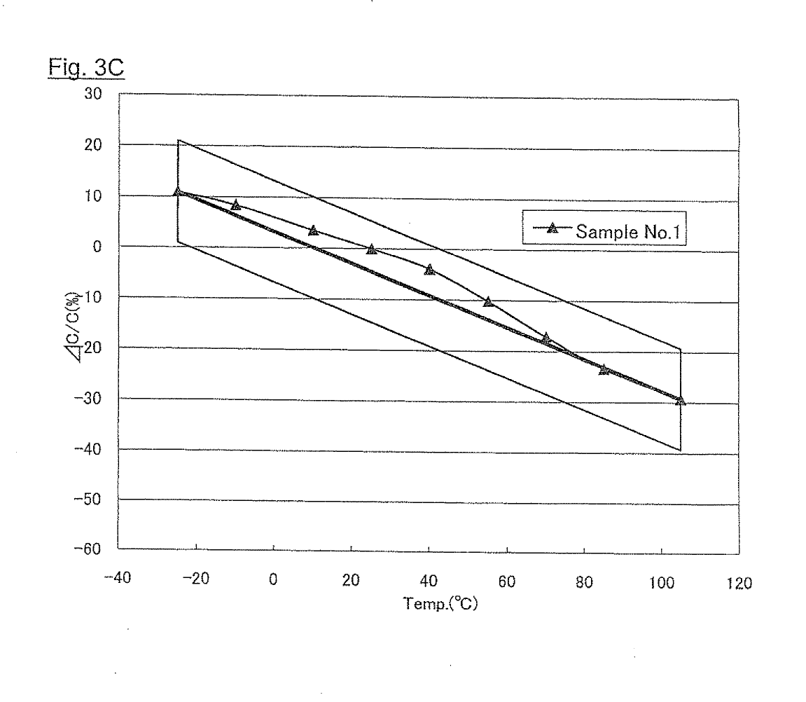

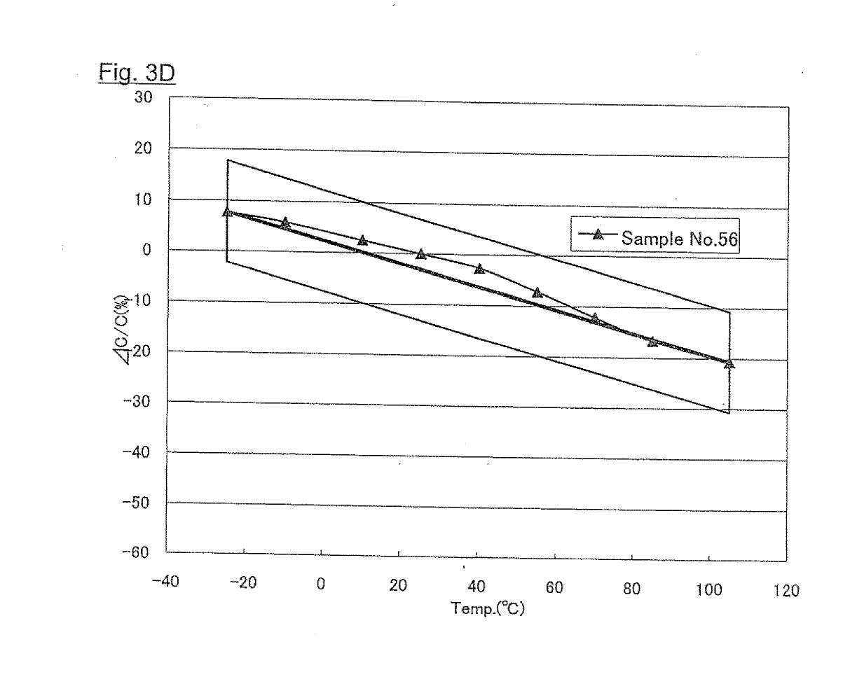

Except that the contents of the sixth subcomponent were set as values shown in Table 5 in the sample 1, 8, 13, 17, 21, 25, 39 and 46, the capacitor samples were made as similar to the sample 1 and the evaluation was made as similar to the sample 1. The results are shown in Tables 5 and 6. Further, for the samples 54, 55, 1 and 56, the graphs showing the capacitance change rate in the range of −25 to 105° C. on the basis of capacitance at 25° C. were shown in FIGS. 3A to 3D, respectively.

TABLE 5

| | | | | | | | contents of subcomponents with | | | | | |
|---|---|---|---|---|---|---|---|---|---|---|---|---|
| | | | | | | | respect to 100 moles of main component [mol] | | | | | |
| | | average | compositions of | | | | | | 3rd | | | |
| | | particle | main component | | | | | 2nd | subcom- | 4th | 5th | 6th |
| | | diameter | (Ba_{1-x-y}SrₓCa_{y})ₘ(Ti_{1-z}Zr_{z})O₃ | | | | 1st | subcom- | ponent | subcomponent | subcomponent | subcomponent |
| | | of main | | | | m | subcom- | ponent | (rare | 0.5 to 5 | (V, Mo, W, | 0 to 30 |
| | | compo- | x | y | z | 0.950 | ponent | (Mn, Cr) | earth) | kind of 4th | Ta, Nb) | kind of 6th |
| | item | nent | 0.20 to | 0 to | 0 to | to | (Mg) | 0.05 to 2 | 1 to 8 | subcom- | 0 to 0.2 | subcom- |
| No. | range | [mm] | 0.40 | 0.20 | 0.30 | 1.050 | 0.5 to 5 | A | R | ponent | D | ponent |

| | | | | | | | | | | | | | | | | |
|---|---|---|---|---|---|---|---|---|---|---|---|---|---|---|---|---|
| 54* | 0.35 | 0.3 | 0 | 0 | 1 | 2 | Mn | 0.2 | Y | 4 | BaCaSiO3 | 3 | V | 0.06 | BaSrZrO3 | 0 |
| 55 | 0.35 | 0.3 | 0 | 0 | 1 | 2 | Mn | 0.2 | Y | 4 | BaCaSiO3 | 3 | V | 0.06 | BaSrZrO3 | 5 |
| 1 | 0.35 | 0.3 | 0 | 0 | 1 | 2 | Mn | 0.2 | Y | 4 | BaCaSiO3 | 3 | V | 0.06 | BaSrZrO3 | 15 |
| 56 | 0.35 | 0.3 | 0 | 0 | 1 | 2 | Mn | 0.2 | Y | 4 | BaCaSiO3 | 3 | V | 0.06 | BaSrZrO3 | 30 |
| 57* | 0.35 | 0.3 | 0 | 0 | 1 | 2 | Mn | 0.2 | Y | 4 | BaCaSiO3 | 3 | V | 0.06 | BaSrZrO3 | 35 |
| 58* | 0.35 | 0.25 | 0.15 | 0.2 | 1 | 2 | Mn | 0.2 | Y | 4 | BaCaSiO3 | 3 | V | 0.06 | BaSrZrO3 | 0 |
| 59 | 0.35 | 0.25 | 0.15 | 0.2 | 1 | 2 | Mn | 0.2 | Y | 4 | BaCaSiO3 | 3 | V | 0.06 | BaSrZrO3 | 5 |
| 8 | 0.35 | 0.25 | 0.15 | 0.2 | 1 | 2 | Mn | 0.2 | Y | 4 | BaCaSiO3 | 3 | V | 0.06 | BaSrZrO3 | 15 |
| 60 | 0.35 | 0.25 | 0.15 | 0.2 | 1 | 2 | Mn | 0.2 | Y | 4 | BaCaSiO3 | 3 | V | 0.06 | BaSrZrO3 | 30 |
| 61* | 0.35 | 0.25 | 0.15 | 0.2 | 1 | 2 | Mn | 0.2 | Y | 4 | BaCaSiO3 | 3 | V | 0.06 | BaSrZrO3 | 35 |
| 62* | 0.35 | 0.3 | 0 | 0 | 1.05 | 2 | Mn | 0.2 | Y | 4 | BaCaSiO3 | 3 | V | 0.06 | BaSrZrO3 | 0 |
| 63 | 0.35 | 0.3 | 0 | 0 | 1.05 | 2 | Mn | 0.2 | Y | 4 | BaCaSiO3 | 3 | V | 0.06 | BaSrZrO3 | 5 |
| 13 | 0.35 | 0.3 | 0 | 0 | 1.05 | 2 | Mn | 0.2 | Y | 4 | BaCaSiO3 | 3 | V | 0.06 | BaSrZrO3 | 15 |
| 64 | 0.35 | 0.3 | 0 | 0 | 1.05 | 2 | Mn | 0.2 | Y | 4 | BaCaSiO3 | 3 | V | 0.06 | BaSrZrO3 | 30 |
| 65* | 0.35 | 0.3 | 0 | 0 | 1.05 | 2 | Mn | 0.2 | Y | 4 | BaCaSiO3 | 3 | V | 0.06 | BaSr2rO3 | 35 |
| 66* | 0.35 | 0.3 | 0 | 0 | 1 | 5 | Mn | 0.2 | Y | 4 | BaCaSiO3 | 3 | V | 0.06 | BaSrZrO3 | 0 |
| 67 | 0.35 | 0.3 | 0 | 0 | 1 | 5 | Mn | 0.2 | Y | 4 | BaCaSiO3 | 3 | V | 0.06 | BaSrZrO3 | 5 |
| 17 | 0.35 | 0.3 | 0 | 0 | 1 | 5 | Mn | 0.2 | Y | 4 | BaCaSiO3 | 3 | V | 0.06 | BaSrZrO3 | 15 |
| 68 | 0.35 | 0.3 | 0 | 0 | 1 | 5 | Mn | 0.2 | Y | 4 | BaCaSiO3 | 3 | V | 0.06 | BaSrZrO3 | 30 |
| 69* | 0.35 | 0.3 | 0 | 0 | 1 | 5 | Mn | 0.2 | Y | 4 | BaCaSiO3 | 3 | V | 0.06 | BaSrZrO3 | 35 |
| 70* | 0.35 | 0.3 | 0 | 0 | 1 | 2 | Mn | 2 | Y | 4 | BaCaSiO3 | 3 | V | 0.06 | BaSrZrO3 | 0 |
| 71 | 0.35 | 0.3 | 0 | 0 | 1 | 2 | Mn | 2 | Y | 4 | BaCaSiO3 | 3 | V | 0.06 | BaSrZrO3 | 5 |
| 21 | 0.35 | 0.3 | 0 | 0 | 1 | 2 | Mn | 2 | Y | 4 | BaCaSiO3 | 3 | V | 0.06 | BaSrZrO3 | 15 |
| 72 | 0.35 | 0.3 | 0 | 0 | 1 | 2 | Mn | 2 | Y | 4 | BaCaSiO3 | 3 | V | 0.06 | BaSrZrO3 | 30 |
| 73* | 0.35 | 0.3 | 0 | 0 | 1 | 2 | Mn | 2 | Y | 4 | BaCaSiO3 | 3 | V | 0.06 | BaSrZrO3 | 35 |
| 74* | 0.35 | 0.3 | 0 | 0 | 1 | 2 | Mn | 0.2 | Y | 1 | BaCaSiO3 | 3 | V | 0.06 | BaSrZrO3 | 0 |
| 75 | 0.35 | 0.3 | 0 | 0 | 1 | 2 | Mn | 0.2 | Y | 1 | BaCaSiO3 | 3 | V | 0.06 | BaSrZrO3 | 5 |
| 25 | 0.35 | 0.3 | 0 | 0 | 1 | 2 | Mn | 0.2 | Y | 1 | BaCaSiO3 | 3 | V | 0.06 | BaSrZrO3 | 15 |
| 76 | 0.35 | 0.3 | 0 | 0 | 1 | 2 | Mn | 0.2 | Y | 1 | BaCaSiO3 | 3 | V | 0.06 | BaSrZrO3 | 30 |
| 77* | 0.35 | 0.3 | 0 | 0 | 1 | 2 | Mn | 0.2 | Y | 1 | BaCaSiO3 | 3 | V | 0.06 | BaSrZrO3 | 35 |
| 78* | 0.35 | 0.3 | 0 | 0 | 1 | 2 | Mn | 0.2 | Y | 4 | BaCaSiO3 | 0.5 | V | 0.06 | BaSrZrO3 | 0 |
| 79 | 0.35 | 0.3 | 0 | 0 | 1 | 2 | Mn | 0.2 | Y | 4 | BaCaSiO3 | 0.5 | V | 0.06 | BaSrZrO3 | 5 |
| 39 | 0.35 | 0.3 | 0 | 0 | 1 | 2 | Mn | 0.2 | Y | 4 | BaCaSiO3 | 0.5 | V | 0.06 | BaSrZrO3 | 15 |
| 80 | 0.35 | 0.3 | 0 | 0 | 1 | 2 | Mn | 0.2 | Y | 4 | BaCaSiO3 | 0.5 | V | 0.06 | BaSrZrO3 | 30 |
| 81* | 0.35 | 0.3 | 0 | 0 | 1 | 2 | Mn | 0.2 | Y | 4 | BaCaSiO3 | 0.5 | V | 0.06 | BaSrZrO3 | 35 |
| 82* | 0.35 | 0.3 | 0 | 0 | 1 | 2 | Mn | 0.2 | Y | 4 | BaCaSiO3 | 3 | V | 0.2 | BaSrZrO3 | 0 |
| 83 | 0.35 | 0.3 | 0 | 0 | 1 | 2 | Mn | 0.2 | Y | 4 | BaCaSiO3 | 3 | V | 0.2 | BaSrZrO3 | 5 |
| 46 | 0.35 | 0.3 | 0 | 0 | 1 | 2 | Mn | 0.2 | Y | 4 | BaCaSiO3 | 3 | V | 0.2 | BaSrZrO3 | 15 |
| 84 | 0.35 | 0.3 | 0 | 0 | 1 | 2 | Mn | 0.2 | Y | 4 | BaCaSiO3 | 3 | V | 0.2 | BaSrZrO3 | 30 |
| 85* | 0.35 | 0.3 | 0 | 0 | 1 | 2 | Mn | 0.2 | Y | 4 | BaCaSiO3 | 3 | V | 0.2 | BaSrZrO3 | 35 |

“*” indicates a sample which is without the range of the present invention
Italicized numerical value is without the range of the invention.

TABLE 6

| | | average | | | | capacity temperature | high | |
|---|---|---|---|---|---|---|---|---|
| | | particle | initial characteristic | | | change rate | temperature | |
| | | diameter | specific | dielectric | insulation | (TC) [%] | accelerated | |
| | | of | permittivity | loss | resistance | −25° C.~105° C. | lifetime | |
| | | sintered | (es) | (tanδ) [%] | (IR) [MΩ] | a: −1800 ppm/° C. | (HALT) [b] | |
| | item | body | 500 | 3 | 1.0E+10 | to | 3.1 | good or |
| No. | range | [mm] | or more | or less | or more | −5500 ppm/° C. | or more | bad |

| | | | | | | | |
|---|---|---|---|---|---|---|---|
| 54* | 0.4 | 1400 | 0.89 | 5.7E+11 | −5,350 | 48 | good |
| 55 | 0.4 | 1288 | 0.95 | 5.2E+11 | −4,150 | 44 | good |
| 1 | 0.4 | 875 | 1.1 | 4.2E+11 | −3,100 | 52 | good |
| 56 | 0.4 | 635 | 1.2 | 6.5E+11 | −2,200 | 49 | good |

| 57* | — | Do Not Sinter Densely | | | | | bad |
|---|---|---|---|---|---|---|---|
| 58 | 0.4 | 1150 | 1.02 | 8.9E+11 | −4,750 | 28 | good |
| 59 | 0.4 | 1150 | 1.05 | 6.5E+11 | −4,000 | 23 | good |
| 8 | 0.4 | 719 | 1.1 | 7.6E+11 | −3,200 | 24 | good |
| 60 | 0.5 | 622 | 1.1 | 5.5E+11 | −2,150 | 22 | good |
| 61* | — | Do Not Sinter Densely | | | | | bad |
| 62* | 0.4 | 1420 | 0.95 | 4.2E+11 | −5,150 | 25 | good |
| 63 | 0.4 | 1189 | 1.01 | 5.3E+11 | −4,050 | 22 | good |
| 13 | 0.4 | 888 | 1.04 | 4.1E+11 | −3,100 | 29 | good |
| 64 | 0.4 | 543 | 1.1 | 6.5E+11 | −1,900 | 31 | good |
| 65* | — | Do Not Sinter Densely | | | | | bad |
| 66* | 0.4 | 1050 | 1.3 | 4.4E+11 | −5,100 | 21 | good |
| 67 | 0.4 | 857 | 1.3 | 5.6E+11 | −4,050 | 22 | good |
| 17 | 0.4 | 656 | 1.4 | 8.8E+11 | −3,100 | 34 | good |
| 68 | 0.4 | 525 | 1.5 | 7.6E+11 | −2,050 | 32 | good |
| 69* | — | Do Not Sinter Densely | | | | | bad |
| 70* | 0.5 | 1380 | 1.4 | 9.8E+11 | −4,900 | 7.6 | good |
| 71 | 0.5 | 1153 | 1.4 | 7.2E+11 | −4,000 | 12 | good |
| 21 | 0.5 | 863 | 1.45 | 7.6E+11 | −3,100 | 13 | good |
| 72 | 0.6 | 674 | 1.5 | 7.7E+11 | −2,000 | 15 | good |
| 73* | — | Do Not Sinter Densely | | | | | bad |
| 74* | 0.4 | 1510 | 0.75 | 6.7E+11 | −4,650 | 18 | good |
| 75 | 0.4 | 1205 | 0.73 | 7.5E+11 | −3,950 | 15 | good |
| 25 | 0.4 | 944 | 0.6 | 5.5E+11 | −3,050 | 22 | good |
| 76 | 0.5 | 754 | 0.55 | 5.6E+11 | −2,150 | 19 | good |
| 77* | — | Do Not Sinter Densely | | | | | bad |
| 78* | 0.4 | 1550 | 0.91 | 1.2E+11 | −5,300 | 20 | good |
| 79 | 0.4 | 1250 | 1.1 | 2.4E+11 | −3,950 | 34 | good |
| 39 | 0.4 | 969 | 1.23 | 3.3E+11 | −2,800 | 25 | good |
| 80 | 0.5 | 615 | 1.3 | 2.8E+11 | −1,850 | 24 | good |
| 81* | — | Do Not Sinter Densely | | | | | bad |
| 82* | 0.4 | 1400 | 0.84 | 2.3E+10 | −5,250 | 72 | good |
| 83 | 0.4 | 1198 | 0.91 | 1.5E+11 | −4,050 | 76 | good |
| 46 | 0.4 | 875 | 0.94 | 2.1E+10 | −2,950 | 65 | good |
| 84 | 0.5 | 650 | 0.99 | 2.2E+11 | −1,950 | 55 | good |

| | | | |
|---|---|---|---|
| 85* | — | Do Not Sinter Densely | bad |

“*” indicates a sample which is without the range of the present invention
Italicized numerical value is without the range of the invention.

As shown in Tables 5 and 6, when the content of sixth subcomponent is increased with respect to 100 moles of the main component within the range of the present invention, the value “a” of the slope became smaller while satisfying the other characteristics. Namely, it was confirmed that by changing the content of the sixth subcomponent, the slope “a” could be controlled within the range of the present invention.

Also, when the content of the sixth subcomponent was larger than the range of the present invention, the sample showed poor sintering.

As shown in FIGS. 3A to 3D, in the samples 54, 55, 1 and 56 which have the same composition except for the content of the sixth subcomponent, it was confirmed visually that within the temperature range of −25 to 105° C., the slope showing the capacitance characteristic on the basis of capacitance at 25° C. changed in the range of −5350 to −2200 ppm/° C. and that the capacitance change rate on the basis of capacitance at 25° C. was in the range of −10 to +10% with respect to the slope.

What is claimed is:

1. A dielectric ceramic composition comprising
a main component expressed by a general formula of (Ba_{1-x-y}SrₓCa_{y})ₘ(Ti_{1-z}Zr_{z})O₃,
a first subcomponent consisting of an oxide of Mg,
a second subcomponent consisting of an oxide of at least one kind of element selected from the group consisting of Mn and Cr,
a third subcomponent consisting of an oxide of R, where R is at least one kind selected from the group consisting of Y, La Ce, Pr, Nd, Sm, Gd, Tb, Dy, Ho and Yb,
a fourth subcomponent consisting of an oxide including Si, and
a sixth subcomponent consisting of a composite oxide including Ba, Sr and Zr,
wherein the general formula shows 0.20≦x≦0.40, 0≦y≦0.20, 0≦z≦0.30, and 0.950≦m≦1.050
and ratios of the respective subcomponents with respect to 100 moles of said main component are
the first subcomponent: 0.5 to 5 moles in terms of element,
the second subcomponent: 0.05 to 2 moles in terms of element,
the third subcomponent: 1 to 8 moles in terms of element,
the fourth subcomponent: 0.5 to 5 moles in terms of an oxide or a composite oxide,
the sixth subcomponent: 5 to 30 moles in terms of a composite oxide and within a temperature range of −25 to 105° C., a capacitance change rate on the basis of a capacitance at 25° C. is within −15 to +5%, with respect to a slope “a” which shows capacity temperature characteristic on the basis of the capacitance at 25° C., and said slope “a” is −5500 to −1800 ppm/° C.

2. The dielectric ceramic composition as set forth in claim 1,
wherein said y and z are 0 in the general formula of the main component.

3. The dielectric ceramic composition as set forth in claim 1 further comprising
a fifth subcomponent consisting of at least one kind of element selected from the group consisting of V, Mo, W, Ta and Nb,
wherein a ratio of the fifth subcomponent with respect to 100 moles of said main component is 0 to 0.2 moles in terms of each element.

4. The dielectric ceramic composition as set forth in claim 2 further comprising
a fifth subcomponent consisting of at least one kind element selected from the group consisting of V, Mo, W, Ta and Nb,
wherein a ratio of the fifth subcomponent with respect to 100 moles of said main component is 0 to 0.2 moles in terms of each element.

5. An electronic device comprising a dielectric layer composed of the dielectric ceramic composition as set forth in claim 1.

6. An electronic device comprising a dielectric layer composed of the dielectric ceramic composition as set forth in claim 2.

7. An electronic device comprising a dielectric layer composed of the dielectric ceramic composition as set forth in claim 3.

8. An electronic device comprising a dielectric layer composed of the dielectric ceramic composition as set forth in claim 4.
